(19) United States
(12) Patent Application Publication
(10) Pub. No.: US 2018/0147877 A1
(43) Pub. Date: May 31, 2018

(54) IMAGE

(71) Applicant: Konica Minolta, Inc., Tokyo (JP)

(72) Inventors: Shogo Watanabe, Tokyo (JP); Go Yamaguchi, Tokyo (JP); Kimie Tachibana, Tokyo (JP)

(21) Appl. No.: 15/819,510

(22) Filed: Nov. 21, 2017

(30) Foreign Application Priority Data
Nov. 25, 2016 (JP) 2016-229128

(51) Int. Cl. B41M 5/50

(52) U.S. Cl. CPC B41M 5/50

(57) ABSTRACT

An image includes a plurality of dots formed from droplets of an active ray curable inkjet ink, wherein an average value of surface roughness (Sa) measured from the plurality of dots in an area of a reference length of 20 μm set on a surface of one dot arbitrarily selected from the plurality of dots is 0.05 μm or more and 0.2 μm or less.

Japanese Patent Application No. 2016-229128 filed on Nov. 25, 2016, including description, claims, drawings, and abstract the entire disclosure is incorporated herein by reference in its entirety.

### BACKGROUND

### Technological Field

The present invention relates to an image formed from an active ray curable inkjet ink.

### Description of the Related Art

An inkjet recording method is used in various printing fields because of being able to form an image easily and inexpensively. One of the inkjet recording methods is an active ray curable inkjet ink method for causing droplets of an active ray curable inkjet ink to land on a substrate, and then irradiating the active ray curable inkjet ink with an active ray and curing the active ray curable inkjet ink to form an image. This method can form an image having high scratch resistance and adhesion even on a substrate having low ink absorbability, and therefore has attracted attention in recent years.

For example, JP 2003-211651 A describes an inkjet recording method for adjusting glossiness of an image forming unit by ejecting a radiation curable ink onto a surface of a recording material, and then controlling the energy amount of the radiation for curing the ink which has landed or by controlling time until irradiation with the radiation for curing the ink which has landed.

In addition, in JP 2006-159684 A, it is possible to adjust gloss of an image with an image recording apparatus including a recording head for discharging an ink containing a cationic curable monomer component onto a substrate to record an image, a light irradiation device for irradiating the ink which has landed on the substrate with an active ray to cure the ink, a gloss designating unit for designating gloss of the image, and a controller for controlling the recording head and the light irradiation device, in which the controller controls the light irradiation device in accordance with the gloss designated by the gloss designating unit to adjust the irradiation amount of the active ray.

### SUMMARY

JP 2003-211651 A and JP 2006-159684 A describe a method for uniformly adjusting gloss of an entire image. Meanwhile, the present invention provides an image based on a completely new concept, a composition and a problem of which have not been recognized so far.

To achieve the abovementioned object, according to an aspect of the present invention, an image reflecting one aspect of the present invention comprises a plurality of dots formed from droplets of an active ray curable inkjet ink, wherein an average value of surface roughness (Sa) measured from the plurality of dots in an area of a reference length of 20 μm set on a surface of one dot arbitrarily selected from the plurality of dots is 0.05 μm or more and 0.2 μm or less.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1A is a schematic diagram illustrating a configuration of a dot in an area with a low printing ratio in prior art;

FIG. 1B is a schematic diagram illustrating a configuration of a dot in an area with a high printing ratio in related art;

FIG. 2A is a schematic diagram illustrating a configuration of a dot in an area with a low printing ratio in an embodiment of the present invention;

FIG. 2B is a schematic diagram illustrating a configuration of a dot in an area with a high printing ratio in an embodiment of the present invention; and

FIG. 3 is a graph illustrating a relationship between a printing ratio and a 60° gloss value in an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

The present invention relates to an image formed from an active ray curable inkjet ink. The image is only required to be information recorded on a substrate using an active ray curable inkjet ink, and may be a single letter, an assembly of letters, a figure, a picture, a photograph, or the like.

The image formed from an active ray curable inkjet ink is formed by discharging droplets of the active ray curable inkjet ink from a nozzle of a recording head for inkjet, causing the droplets to land on a substrate, and curing the droplets which have landed by irradiation with an active ray. The droplets which have landed and have been cured form a dot constituting an image.

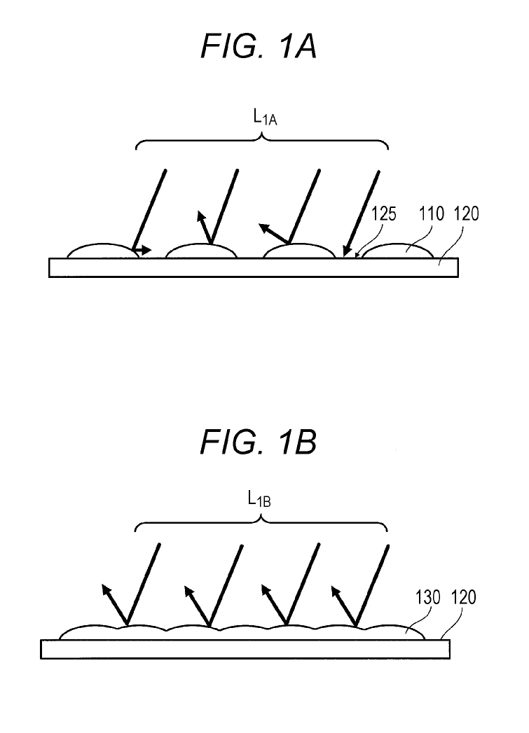

FIG. 1A illustrates a schematic configuration of a dot 110 in an area with a low printing ratio included in an image in prior art. In this exemplary area, the number of droplets landing on a unit area is smaller, and the dots 110 formed on a substrate 120 are usually isolated from each other while edges thereof are not adjacent to each other or do not overlap each other. A substrate surface 125 having a lower gloss value has a lower gloss value than a usual surface. Therefore, such an area tends to have a further lower gloss value due to an influence of the substrate surface. In addition, such an area irregularly reflects incident light L_{1A}, and therefore has a lower gloss value.

FIG. 1B illustrates a schematic configuration of a dot 130 in an area having a high printing ratio included in an image in prior art. In this exemplary area, the number of droplets landing on a unit area is larger, and edges of the dots 130 formed on a substrate 140 are sometimes adjacent to each other or overlap each other. Such an area has a smoother surface and regularly reflects incident light L_{1B}, and therefore has a higher gloss value.

Therefore, in prior art, it is considered that a difference in gloss occurs in an image because incident light exhibits different reflection behaviors between areas having different printing ratios.

Meanwhile, in the present invention, by roughening a surface of a formed dot microscopically, light with which the dot is irradiated is caused to reflect irregularly, and a gloss value can be adjusted to almost the same value regardless of a difference in printing ratio between areas included in an image.

Note that a surface of an image formed by an active ray curable inkjet ink is not perfectly flat also in prior art, as illustrated in FIG. 1B or the like. According to methods described in JP 2003-211651 A, JP 2006-159684 A, and the like, it is considered that a macro height difference can be formed on a surface of an image. However, with irregularities to such an extent, it is insufficient to reduce a difference in gloss due to the difference in printing ratio and to suppress discomfort due to a difference in gloss in a formed image. Meanwhile, in the present invention, by roughening a surface of a dot microscopically, discomfort due to a difference in gloss in a formed image is more effectively suppressed.

The surface of the dot roughened microscopically may have irregularities, protrusions, recesses, or pores formed thereon.

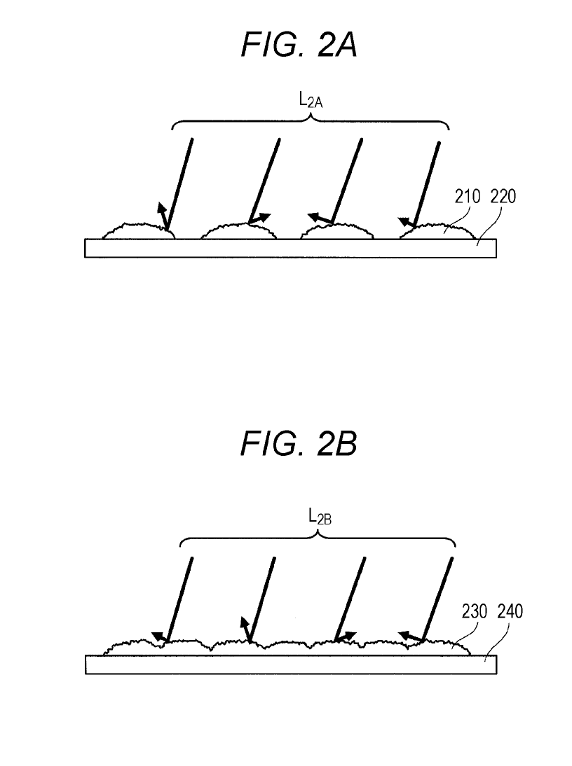

FIG. 2A illustrates a schematic configuration of a dot 210 obtained by roughening a surface of the dot in the area with a low printing ratio microscopically in an embodiment of the present invention. In this exemplary area, the dots 210 with roughened surfaces are usually isolated from each other on a substrate 220.

FIG. 2B illustrates a schematic configuration of a dot 230 obtained by roughening a surface of the dot in the area with a high printing ratio microscopically in an embodiment of the present invention. In this exemplary area, edges of the dots 230 with roughened surfaces formed on a substrate 240 may be adjacent to each other or overlap each other.

In FIGS. 2A and 2B illustrating an embodiment of the present invention, the surfaces of the formed dots are roughened microscopically, and reflect both incident light L_{2A} and L_{2B} with almost the same degree of irregularity. Therefore, a difference in gloss between the area with a high printing ratio and the area with a low printing ratio in an image can be reduced. As a result, an image having less discomfort due to a difference in gloss in a formed image and a better appearance is provided.

In an embodiment of the present invention, the surface of the dot roughened microscopically has an average value of surface roughness (Sa) of 0.05 μm or more and 0.2 μm or less.

The value Sa is measured on a surface of one of the plurality of dots included in an image. As illustrated in FIG. 2B, in an area with a high printing ratio, edges of the dots may be adjacent to each other or overlap each other. Also in such a case, the value Sa is preferably measured on a surface of one dot. Even in an area with a high printing ratio, each of the dots can be identified by observing each of the dots from a top surface thereof with a microscope or the like.

The average value of surface roughness (Sa) is an arithmetic average height in a certain area defined by a reference length, and is measured in accordance with ISO 25178-2 based on a three-dimensional parameter of the shape of an object. The three-dimensional parameter is information representing the shape of an object obtained by scanning an image surface with a laser or the like. A measuring method may be a contact method or a non-contact method.

In an embodiment of the present invention, one dot is observed with a laser microscope VK-X250 manufactured by KEYENCE CORPORATION at an objective lens magnification of 150 times, an area of a reference length of 20 μm is set within an area of 20 μm×20 μm at a center of the dot, and height data in the area is measured. The value Sa in the above area can be calculated from the height data measured. Note that a noise, undulation, or the like in the height data is preferably corrected appropriately with a low-pass filter (S-filter) and a high-pass filter (L-filter) before the value Sa is calculated.

At this time, the average value of Sa obtained by setting an area of a reference length of 20 μm for each of the plurality of dots and measuring surface roughnesses from the plurality of dots is preferably 0.05 μm or more and 0.2 μm or less. For example, the average value of Sa measured from an area of a reference length of 20 μm at ten positions arbitrarily selected on surfaces of 10 dots is preferably 0.05 μm or more and 0.2 μm or less.

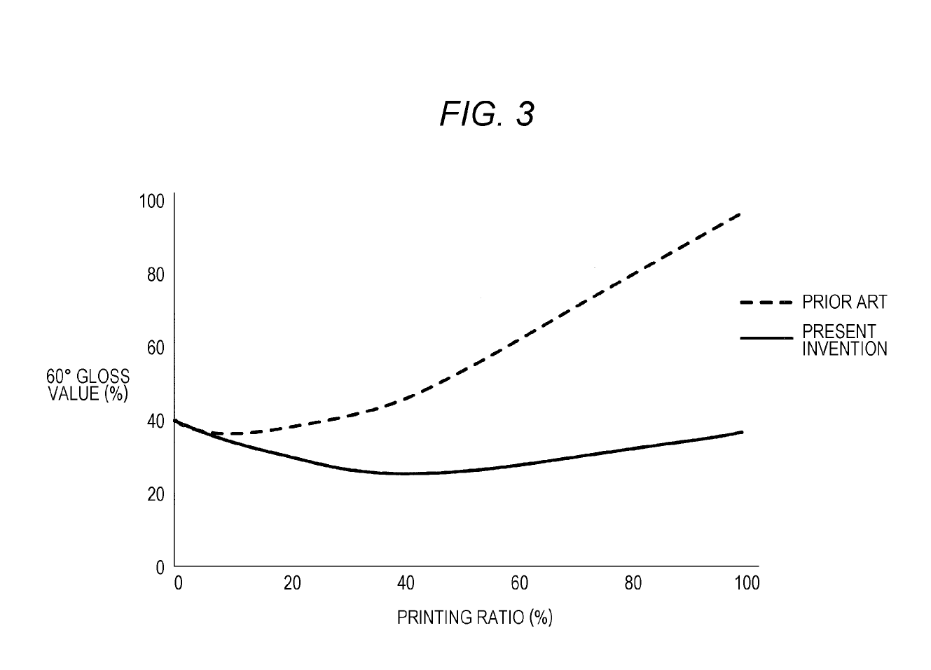

FIG. 3 is a graph illustrating a relationship between a printing ratio of an image and a 60° gloss value in each of prior art and an embodiment of the present invention. As illustrated in FIG. 3, an image formed using an active ray curable ink in prior art usually tends to have higher gloss as a printing ratio is higher. Meanwhile, according to an embodiment of the present invention, even if a printing ratio is increased, gloss is not increased, and therefore a fluctuation width of a gloss value in an image is small. As a result, the present invention eliminates discomfort due to a difference in gloss in a formed image, and can provide an image having a better appearance.

In an embodiment of the present invention, the image includes an area with a printing ratio of 70% or more and 100% or less (hereinafter, also referred to as a “high printing ratio area”).

In an embodiment of the present invention, the average value of Sa measured only from the high printing ratio area is 0.05 μm or more and 0.2 μm or less.

In an embodiment of the present invention, a 60° gloss value of the high printing ratio area is 15 or more and 45 or less.

In an embodiment of the present invention, the image includes an area with a printing ratio of 5% or more and 50% or less (hereinafter, also referred to as a “low printing ratio area”).

In an embodiment of the present invention, the average value of Sa measured only from the low printing ratio area is 0.05 μm or more and 0.2 μm or less.

In an embodiment of the present invention, a 60° gloss value of the low printing ratio area is 15 or more and 45 or less.

In an embodiment of the present invention, the image includes both the high printing ratio area and the low printing ratio area.

In an embodiment of the present invention, the average value of Sa measured only from the high printing ratio area and the average value of Sa measured from only the low printing ratio area are both 0.05 μm or more and 0.2 μm or less.

In an embodiment of the present invention, a difference in 60° gloss value between the high printing ratio area and the low printing ratio area is 3 or more and 20 or less.

In an embodiment of the present invention, the image has a 60° gloss value of 15 or more and 45 or less all the time regardless of a printing ratio.

The printing ratio can be determined from a resolution of an inkjet head, presumed to have been used for forming an image, for example. Specifically, from the resolution of the inkjet head, a dot diameter necessary for filling up a solid image formed using the inkjet head is determined. A value obtained by multiplying the landing amount of an active ray curable ink necessary for obtaining the dot diameter by 4×√2 is used as the landing amount of the ink for obtaining a solid image with a printing ratio of 100% using the inkjet head. A printing ratio in a certain area in an image can be estimated to be a value obtained by dividing the landing amount (volume of ink) of an active ray curable ink contained in the area by the landing amount of the ink for obtaining a solid image with a printing ratio of 100%.

The 60° gloss value can be a value measured with a known gloss meter (for example, handy gloss meter PG-II manufactured by Nippon Denshoku Industries Co., Ltd.).

A dot surface having the value Sa within the above range is roughened microscopically, and therefore reflects incident light irregularly. Therefore, the dot surface having the value Sa within the above range can reduce gloss of an image regardless of a difference in printing ratio.

A surface of a dot formed from an active ray curable inkjet ink is usually smooth, and Sa determined therefrom is smaller than the above range. Meanwhile, in the present invention, a surface of a dot is roughened microscopically. Therefore, in the present invention, a difference in gloss in an image is small regardless of a difference in printing ratio. It has not been known until now that a difference in gloss in an image due to a difference in printing ratio is reduced due to a rough surface of a dot surface. Therefore, in prior art, a dot having a surface roughened microscopically, in other words, a dot having Sa within the above range is not formed, and there is no motivation to form the dot. In contrast, in the present invention, a dot surface is roughened microscopically, and therefore a difference in gloss in an image is small regardless of a difference in printing ratio between areas.

In an embodiment of the present invention, the image may be a monochrome image formed using a single kind of active ray curable inkjet ink. At this time, the dot includes a colored dot exhibiting a single color.

In an embodiment of the present invention, the image may be a color image formed using a plurality of kinds of active ray curable inkjet inks having different kinds or amounts of coloring materials contained therein. At this time, the dot includes a plurality of colored dots exhibiting different colors.

In an embodiment of the present invention, the image may be formed using an active ray curable inkjet ink which is a so-called clear ink not containing a coloring material, or may be formed using the clear ink and a single kind or a plurality of kinds of active ray curable inkjet inks containing a coloring material.

In an embodiment of the present invention, the plurality of kinds of active ray curable inkjet inks can be selected from a yellow ink, a magenta ink, a cyan ink, a black ink, and a white ink. At this time, the dot in the above embodiment of the present invention includes a plurality of colored dots selected from a yellow dot formed using the yellow ink, a magenta dot formed using the magenta ink, a cyan dot formed using the cyan ink, a black dot formed using the black ink, and a white dot formed using the white ink.

In an embodiment of the present invention, the color image includes a high printing ratio area having a printing ratio of 70% or more and 100% or less.

In an embodiment of the present invention, the average value of Sa measured only from the high printing ratio area included in the color image is 0.05 μm or more and 0.2 μm or less.

In an embodiment of the present invention, a 60° gloss value of the high printing ratio area included in the color image is 15 or more and 45 or less.

In an embodiment of the present invention, the color image includes a low printing ratio area having a printing ratio of 5% or more and 50% or less.

In an embodiment of the present invention, the average value of Sa measured only from the low printing ratio area included in the color image is 0.05 μm or more and 0.2 μm or less.

In an embodiment of the present invention, a 60° gloss value of the low printing ratio area included in the color image is 15 or more and 45 or less.

In an embodiment of the present invention, the color image includes both a high printing ratio area and a low printing ratio area.

In an embodiment of the present invention, the average value of Sa measured only from the high printing ratio area included in the color image and the average value of Sa measured only from the low printing ratio area included in the color image are both 0.05 μm or more and 0.2 μm or less.

In an embodiment of the present invention, a difference in 60° gloss value between the high printing ratio area and the low printing ratio area included in the color image is 3 or more and 20 or less.

In an embodiment of the present invention, the color image includes at least one color of colored dots having the average value of Sa of 0.05 μm or more and 0.2 μm or less, measured only from the colored dot. The color image includes preferably two colors of colored dots, more preferably three colors of colored dots having the average value of Sa of 0.05 μm or more and 0.2 μm or less. The color image still more preferably consists only of colored dots having the average value of Sa of 0.05 μm or more and 0.2 μm or less.

In an embodiment of the present invention, from the color image, a pair of colored dots of two colors consisting of colored dots of two different colors selected from the plurality of colored dots can be set. In the pair of the colored dots of two colors, a difference between the average value of Sa measured only from the colored dots of one color constituting the pair and the average value of Sa measured only from the colored dots of the other color constituting the pair is 0.15 μm or less.

In an embodiment of the present invention, the color image includes at least one pair of colored dots of two colors in which a difference in the average value of Sa is 0.15 μm or less. The color image includes preferably two pairs, more preferably three or more pairs of colored dots of two colors in which the difference in the average value of Sa is 0.15 μm or less. A difference between the average value of Sa measured only from dots of one color constituting the color image and the average value of Sa measured only from dots of the other color is still more preferably 0.15 μm or less all the time.

In an embodiment of the present invention, a dot surface of each color is roughened microscopically so as to satisfy the conditions of Sa even in a color image, and therefore a difference in gloss in an image is small regardless of a difference in printing ratio between areas. For example, when Sa in the high printing ratio area of the yellow dot and Sa in the low printing ratio area thereof, and Sa in the high printing ratio area of the cyan dot and Sa in the low printing ratio area thereof are all within the above ranges, discomfort due to a difference in gloss between areas having different printing ratios can be eliminated in both the area formed of the yellow dot and the area formed of the cyan dot. Of course, the same applies to a colored dot of another color. As a result, an image having an excellent appearance even in a full color is provided.

<Active Ray Curable Inkjet Ink>

The active ray curable inkjet ink is a composition containing a photopolymerizable compound, capable of being discharged from a nozzle by an inkjet method, and may further contain a coloring material, a photopolymerization initiator, and other components.

(Photopolymerizable Compound)

The photopolymerizable compound is a compound to be crosslinked or polymerized by irradiation with an active ray. Examples of the active ray include an electron beam, an ultraviolet ray, an a ray, a y ray, and an X ray, and an ultraviolet ray is preferable. The photopolymerizable compound may be a radically polymerizable compound or a cationically polymerizable compound.

The radically polymerizable compound is a compound having a radically polymerizable ethylenically unsaturated bond (a monomer, an oligomer, a polymer, or a mixture thereof). The radically polymerizable compound may be used singly or in combination of two or more kinds thereof.

Examples of the compound having a radically polymerizable ethylenically unsaturated bond include an unsaturated carboxylic acid and a salt thereof, an unsaturated carboxylate compound, an unsaturated carboxylic acid urethane compound, an unsaturated carboxylic acid amide compound and an anhydride thereof, acrylonitrile, styrene, unsaturated polyester, unsaturated polyether, unsaturated polyamide, and unsaturated urethane. Examples of the unsaturated carboxylic acid include (meth)acrylic acid, itaconic acid, crotonic acid, isocrotonic acid, and maleic acid.

Among the compounds, the radically polymerizable compound is preferably an unsaturated carboxylate compound, and more preferably a (meth)acrylate compound. The (meth)acrylate compound may be not only a monomer described below but also an oligomer, a mixture of a monomer and an oligomer, a modified product, an oligomer having a polymerizable functional group, or the like. Here, “(meth)acrylate” means both or either of “acrylate” and “methacrylate”, and “(meth)acrylic” means both or either of “acrylic” and “methacrylic”.

Examples of the (meth)acrylate compound include: a monofunctional monomer such as isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, 2-(meth)acryloyloxyethylhexahydrophthalic acid, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, 2-(meth)acryloyloxyethylsuccinic acid, 2-(meth)acryloyloxyethylphthalic acid, 2-(meth)acryloyloxyethyl-2-hydroxyethyl-phthalic acid, or t-butylcyclohexyl (meth)acrylate; a bifunctional monomer such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A PO adduct di(meth)acrylate, hydroxypivalic acid neopentyl glycol di(meth)acrylate, or polytetramethylene glycol di(meth)acrylate; and a tri- or higher polyfunctional monomer such as trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerol propoxy tri(meth)acrylate, or pentaerythritol ethoxy tetra(meth)acrylate.

The (meth)acrylate compound may be a modified product, and examples thereof include: an ethylene oxide modified (meth)acrylate compounds such as ethylene oxide modified trimethylolpropane tri(meth)acrylate or ethylene oxide modified pentaerythritol tetraacrylate; a caprolactone modified (meth)acrylate compound such as caprolactone modified trimethylolpropane tri(meth)acrylate; and a caprolactam modified (meth)acrylate compound such as caprolactam modified dipentaerythritol hexa(meth)acrylate.

Examples of the ethylene oxide modified (meth)acrylate compound include: 4EO modified hexanediol diacrylate CD561, 3EO modified trimethylolpropane triacrylate SR454, 6EO modified trimethylolpropane triacrylate SR499, and 4EO modified pentaerythritol tetraacrylate SR494 manufactured by Sartomer Co., Inc.; polyethylene glycol diacrylate NK ester A-400, polyethylene glycol diacrylate NK ester A-600, polyethylene glycol dimethacrylate NK ester 9G, and polyethylene glycol dimethacrylate NK ester 14G manufactured by Shin-Nakamura Chemical Co., Ltd.; tetraethylene glycol diacrylate V#335HP manufactured by Osaka Organic Chemical Industry Ltd.; 3PO modified trimethylolpropane triacrylate Photomer 4072 manufactured by Cognis Corporation; 1,10-decanediol dimethacrylate NK ester DOD-N, tricyclodecane dimethanol diacrylate NK Ester A-DCP, and tricyclodecane dimethanol dimethacrylate NK ester DCP manufactured by Shin-Nakamura Chemical Co., Ltd.; and trimethylolpropane PO modified triacrylate Miramer M360 manufactured by Miwon Specialty Chemical Co. Ltd.

The (meth)acrylate compound may be a polymerizable oligomer, and examples of such a polymerizable oligomer include an epoxy (meth)acrylate oligomer, an aliphatic urethane (meth)acrylate oligomer, an aromatic urethane (meth)acrylate oligomer, a polyester (meth)acrylate oligomer, and a linear (meth)acrylic oligomer.

In a case where a cationically polymerizable compound is used as the photopolymerizable compound, an epoxy compound, a vinyl ether compound, an oxetane compound, or the like can be used. The cationically polymerizable compound may be used singly or in combination of two or more kinds thereof.

The epoxy compound is an aromatic epoxide, an alicyclic epoxide, an aliphatic epoxide, or the like, and an aromatic epoxide and an alicyclic epoxide are preferable for enhancing curability.

The aromatic epoxide may be di- or poly-glycidyl ether obtained by a reaction between a polyhydric phenol or an alkylene oxide adduct thereof and epichlorohydrin. Examples of the polyhydric phenol or an alkylene oxide adduct thereof used for the reaction include bisphenol A or an alkylene oxide adduct thereof. The alkylene oxide in the alkylene oxide adduct may be ethylene oxide, propylene oxide, or the like.

The alicyclic epoxide may be a cycloalkane oxide-containing compound obtained by epoxidizing a cycloalkane-containing compound with an oxidizing agent such as hydrogen peroxide or a peracid. A cycloalkane in the cycloalkane oxide-containing compound may be cyclohexene or cyclopentene.

The aliphatic epoxide may be di- or poly-glycidyl ether obtained by a reaction between an aliphatic polyhydric alcohol or an alkylene oxide adduct thereof and epichlorohydrin. Examples of the aliphatic polyhydric alcohol include an alkylene glycol such as ethylene glycol, propylene glycol, or 1,6-hexanediol. An alkylene oxide in the alkylene oxide adduct may be ethylene oxide, propylene oxide, or the like.

Examples of the vinyl ether compound include: a monovinyl ether compound such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexane dimethanol monovinyl ether, n-propyl vinyl ether, isopropyl vinyl ether, isopropenyl ether-o-propylene carbonate, dodecyl vinyl ether, diethylene glycol monovinyl ether, or octadecyl vinyl ether; and a di- or tri-vinyl ether compound such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexane dimethanol divinyl ether, or trimethylolpropane trivinyl ether. Among these vinyl ether compounds, a di- or tri-vinyl ether compound is preferable in consideration of curability, adhesiveness, and the like.

The oxetane compound is a compound having an oxetane ring, and examples thereof include oxetane compounds described in JP 2001-220526 A, JP 2001-310937 A, and JP 2005-255821 A. Specific examples thereof include a compound represented by general formula (1) described in paragraph 0089 of JP 2005-255821 A, a compound represented by general formula (2) described in paragraph 0092 of JP 2005-255821 A, a compound represented by general formula (7) described in paragraph 0107 of JP 2005-255821 A, a compound represented by general formula (8) described in paragraph 0109 of JP 2005-255821 A, and a compound represented by general formula (9) described in paragraph 0116 of JP 2005-255821 A.

The content of the photopolymerizable compound in the active ray curable inkjet ink is preferably 1% by mass or more and 97% by mass or less, more preferably 10% by mass or more and 95% by mass or less, and still more preferably 30% by mass or more and 95% by mass or less relative to the total mass of the ink. In a case where the photopolymerizable compound contains a (meth)acrylate compound, the content of the (meth)acrylate compound is preferably 10% by mass or more relative to the total mass of the ink. An upper limit value of the content of the (meth)acrylate compound may be 95% by mass relative to the total mass of the ink similarly to the above.

(Coloring Material)

The active ray curable inkjet ink may contain a coloring material. The coloring material may be a dye or a pigment, but a pigment is preferable because an image with good weather resistance can be easily obtained. The pigment is not particularly limited, but may be, for example, an organic pigment or an inorganic pigment of the following number described in Color Index.

Examples of red and magenta pigments include Pigment Red 3, 5, 19, 22, 31, 38, 43, 48: 1, 48: 2, 48: 3, 48: 4, 48: 5, 49: 1, 53: 1, 57: 1, 57: 2, 58: 4, 63: 1, 81, 81: 1, 81: 2, 81: 3, 81: 4, 88, 104, 108, 112, 122, 123, 144, 146, 149, 166, 168, 169, 170, 177, 178, 179, 184, 185, 208, 216, 226, and 257, Pigment Violet 3, 19, 23, 29, 30, 37, 50, and 88, and Pigment Orange 13, 16, 20, and 36. Examples of blue and cyan pigments include Pigment Blue 1, 15, 15: 1, 15: 2, 15: 3, 15: 4, 15: 6, 16, 17-1, 22, 27, 28, 29, 36, and 60. Examples of a green pigment include Pigment Green 7, 26, 36, and 50. Examples of a yellow pigment include Pigment Yellow 1, 3, 12, 13, 14, 17, 34, 35, 37, 55, 74, 81, 83, 93, 94, 95, 97, 108, 109, 110, 120, 137, 138, 139, 153, 154, 155, 157, 166, 167, 168, 180, 185, and 193. Examples of a black pigment include Pigment Black 7, 28, and 26.

The pigment preferably has an average particle diameter of 0.08 μm or more and 0.5 μm or less. The pigment has a maximum particle diameter preferably of 0.3 μm or more and 10 μm or less, and more preferably of 0.3 μm or more and 3 μm or less. By adjusting the particle diameter of the pigment, clogging of a nozzle of a recording head can be suppressed, and storage stability of an ink, transparency of an ink, and curing sensitivity can be maintained.

The content of the pigment is preferably 0.1% by mass or more and 20% by mass or less, and more preferably 0.4% by mass or more and 10% by mass or less relative to the total mass of the active ray curable inkjet ink. When the content of the pigment falls within the above range, an obtained image is sufficiently colored and an ejection property is also good.

The pigment is preferably dispersed, for example, by a ball mill, a sand mill, an attritor, a roll mill, an agitator, a Henschel mixer, a colloid mill, an ultrasonic homogenizer, a pearl mill, a wet jet mill, or a paint shaker. The pigment is preferably dispersed such that the average particle diameter of the pigment particles falls within the above range. Dispersion of the pigment is adjusted according to selection of the pigment, a pigment dispersant, and a dispersion medium, dispersion conditions, filtration conditions, and the like.

(Pigment Dispersant)

The active ray curable inkjet ink may further contain a pigment dispersant in order to enhance dispersibility of a pigment. Examples of the pigment dispersant include a hydroxy group-containing carboxylate, a salt of a long chain polyaminoamide and a high molecular weight acid ester, a salt of a high molecular weight polycarboxylic acid, a salt of a long chain polyaminoamide and a polar acid ester, a high molecular weight unsaturated acid ester, a high molecular copolymer, a modified polyurethane, a modified polyacrylate, a polyether ester type anion activator, a naphthalene sulfonic acid formalin condensate salt, an aromatic sulfonic acid formalin condensate salt, polyoxyethylene alkyl phosphate, polyoxyethylene nonyl phenyl ether, and stearyl amine acetate. Examples of a commercially available pigment dispersant include Solsperse series from Avecia Inc. and PB series from Ajinomoto Fine Techno Co., Ltd. (for example, Ajisper PB824).

The content of the dispersant in the active ray curable inkjet ink is preferably 1% by mass or more and 50% by mass or less relative to a pigment.

(Photopolymerization Initiator)

The active ray curable inkjet ink may contain a photopolymerization initiator. When the photopolymerizable compound is a compound having a radically polymerizable functional group, the photopolymerization initiator includes a photo radical initiator. When the photopolymerizable compound is a compound having a cationically polymerizable functional group, the photopolymerization initiator contains a photoacid generator. The ink in an embodiment of the present invention may contain only one kind of photopolymerization initiator or two or more kinds thereof. The photopolymerization initiator may be a combination of both a photo radical initiator and a photoacid generator.

The photo radical initiator includes a cleavage type radical initiator and a hydrogen abstraction type radical initiator.

Examples of the cleavage type radical initiator include: an acetophenone-based initiator including diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-hydroxyethoxy) phenyl-(2-hydroxy-2-propyl) ketone, 1-hydroxycyclohexyl-phenyl ketone, 2-methyl-2-morpholino (4-thiomethylphenyl) propan-1-one, and 2-benzyl-2-dimethylamino-1-(4-morpholinophenyl)-butanone; a benzoin-based initiator including benzoin, benzoin methyl ether, and benzoin isopropyl ether; an acylphosphine oxide-based initiator including 2,4,6-trimethylbenzoin diphenylphosphine oxide; benzyl; and a methylphenyl glyoxy ester.

Examples of the hydrogen abstraction type radical initiator include: a benzophenone-based initiator including benzophenon, methyl o-benzoylbenzoate-4-phenylbenzophenone, 4,4′-dichlorobenzophenone, hydroxybenzophenone, 4-benzoyl-4′-methyl-diphenylsulfide, acrylated benzophenone, 3,3′,4,4′-tetra(t-butylperoxycarbonyl) benzophenone, and 3,3′-dimethyl-4-methoxybenzophenone; a thioxanthone-based initiator including 2-isopropylthioxanthone, 2,4-dimethylthioxanthone, 2,4-diethylthioxanthone, and 2,4-dichlorothioxanthone; an aminobenzophenone-based initiator including Michler's ketone and 4,4′-diethylaminobenzophenone; 10-butyl-2-chloroacridone; 2-ethylanthraquinone; 9,10-phenanthrenequinone; and camphorquinone.

Examples of the photoacid generator include a triarylsulfonium hexafluorophosphate salt, iodonium (4-methylphenyl) (4-(2-methylpropyl) phenyl) hexafluorophosphate, triarylsulfonium hexafluoroantimonate, and 3-methyl-2-butenyltetramethylene sulfonium hexafluoroantimonate.

The content of the photopolymerization initiator in the active ray curable inkjet ink is preferably 0.1% by mass or more and 10% by mass or less, and more preferably 2% by mass or more and 8% by mass or less, although depending on the kind of light for irradiation at the time of ink curing or the photopolymerizable compound, or the like.

(Other Components)

The active ray curable inkjet ink may further contain a photopolymerization initiator aid, a polymerization inhibitor, a surfactant, a leveling additive, a matting agent, an ultraviolet absorber, an infrared absorber, an antibacterial agent, a basic compound for enhancing storage stability of the ink, another resin, a gelling agent, and the like, if necessary.

The photopolymerization initiator aid may be a tertiary amine compound, and is preferably an aromatic tertiary amine compound. Examples of the aromatic tertiary amine compound include N,N-dimethylaniline, N,N-diethylaniline, N,N-dimethyl-p-toluidine, N,N-dimethylamino-p-ethyl benzoate, N,N-dimethylamino-p-isoamylethyl benzoate, N,N-dihydroxyethylaniline, triethylamine, and N,N-dimethylhexylamine. Among these compounds, N,N-dimethylamino-p-ethyl benzoate and N,N-dimethylamino-p-isoamylethyl benzoate are preferable. Only one kind or two or more kinds of these compounds may be contained.

Examples of the polymerization inhibitor include (alkyl) phenol, hydroquinone, catechol, resorcin, p-methoxyphenol, t-butylcatechol, t-butylhydroquinone, pyrogallol, 1,1-picrylhydrazyl, phenothiazine, p-benzoquinone, nitrosobenzene, 2,5-di-t-butyl-p-benzoquinone, dithiobenzoyl disulfide, picric acid, cupferron, aluminum N-nitrosophenylhydroxylamine, tri-p-nitrophenylmethyl, N-(3-oxyanilino-1,3-dimethylbutylidene) aniline oxide, dibutyl cresol, cyclohexanone oxime cresol, guaiacol, o-isopropyl phenol, butyral doxime, methylethyl ketoxime, and cyclohexanone oxime.

Examples of the basic compound for enhancing storage stability of an ink include a basic alkali metal compound, a basic alkaline earth metal compound, and a basic organic compound such as amine.

Examples of the other resin include a resin for adjusting physical properties of a cured film, and examples thereof include a polyester-based resin, a polyurethane-based resin, a vinyl-based resin, an acrylic resin, and a rubber-based resin.

(Component for Roughening Surface of Dot Microscopically)

The active ray curable inkjet ink may contain a component for roughening a surface according to a method for roughening the surface of the dot microscopically, described below.

The component for roughening a surface is described below, and includes a specific tetrazole compound, a polymer having a difference of 1.0 (cal/cm³)^{1/2} or more and 3.0 (cal/cm³)^{1/2} or less in solubility parameter from a photopolymerizable compound, a volatile substance having a boiling point of about 120 to 180° C., a dispersant containing a long-chain alkyl group, and the like.

<Inkjet Recording Method>

An inkjet recording method according to an embodiment of the present invention includes at least (1) a step of discharging ink droplets of an active ray curable inkjet ink from a recording head to cause the ink droplets to land on a substrate, and (2) a step of irradiating the ink droplets which have landed on the substrate with an active ray to cure the ink droplets.

Regarding Step (1)

The amount of one liquid droplet discharged from each nozzle of the recording head depends on a resolution of an image, but is preferably 0.5 pl or more and 50 pl or less, more preferably 0.5 pl or more and 10 pl or less in order to form a high definition image, and still more preferably 0.5 pl or more and 5.0 pl or less.

The substrate can be used without particular limitation. Examples of the substrate include: an absorbable medium including coated paper including art paper, coated paper, lightweight coated paper, fine coated paper, and cast paper, and non-coated paper; a nonabsorbable substrate (plastic substrate) formed of a plastic such as polyester, polyvinyl chloride, polyethylene, polyurethane, polypropylene, an acrylic resin, polycarbonate, polystyrene, an acrylonitrile-butadiene-styrene copolymer, polyethylene terephthalate, or polybutadiene terephthalate; and a substrate including a nonabsorbable inorganic material such as a metal or glass.

A problem of the present invention significantly appears in a case where a gloss value of a substrate surface is relatively low, and therefore an effect of the present invention is also significant in such a case. The above absorbable medium including coated paper and non-coated paper is preferably used, and an absorbable medium having a 60° gloss value of about 10% to 45% is particularly preferably used.

Usually, even in a case of a high-gloss plastic substrate, if gloss of the plastic substrate is lowered by a matting treatment or the like and adjusted to a desired value, an effect of the present invention is significant.

Specific examples of a substrate preferably used include Maricoat paper (60° gloss value: 10% to 20%) manufactured by Hokuetsu Kishu Paper Co., Ltd. and OK Top Coated paper (60° gloss value: 30% to 40%) manufactured by Oji Paper Co., Ltd. When such a substrate is used, a problem of the present invention significantly appears, and an effect of the present invention is also significant.

Regarding Step (2)

By irradiating ink droplets which have landed on a substrate with an active ray, a photopolymerizable compound contained in the ink droplets is polymerized to cure the liquid droplets.

A light source of an active ray is only required to be able to emit the active ray, such as an LED or a halogen lamp. Peak illuminance of an active ray on a substrate surface, the amount of light with which the substrate surface is irradiated, and the like can be arbitrarily set within a known range in a case of forming an image using an active ray curable inkjet ink.

Ink droplets are irradiated with an active ray within 10 seconds, preferably within 0.001 seconds to 5 seconds, more preferably within 0.01 seconds to 2 seconds after the ink droplets adhere to a substrate. Irradiation with an active ray is preferably performed after the ink droplets are discharged from all the recording heads housed in a head carriage.

<Roughening Dot Surface>

A method for roughening a surface of the dot microscopically is not particularly limited. For example, it is only required to form the above irregularities, protrusions, recesses, pores, and the like by the following method.

(a) A Specific Tetrazole Compound is Added to an Active Ray Curable Inkjet Ink.

The tetrazole compound releases a large amount of nitrogen gas upon decomposition by absorbing heat or an ultraviolet ray. For example, through a step of causing ink droplets of an active ray curable inkjet ink containing such a specific tetrazole compound to land on a substrate and irradiating the ink droplets with an active ray such as an ultraviolet ray, the tetrazole compound is decomposed, and fine pores are formed on surfaces of the ink droplets which have landed on the substrate due to fine bubbles generated at this time. Examples of the tetrazole compound include BHT-2NH₃ (manufactured by TOYOBO Co., Ltd.).

(b) A Polymer is Previously Mixed in a Photopolymerizable Compound of an Active Ray Curable Ink.

At this time, the molecular weight of the polymer is set to a certain molecular weight, and a difference in solubility parameter between the photopolymerizable compound and the polymer is set to 1.0 (cal/cm³)^{1/2} or more and 3.0 (cal/cm³)^{1/2} or less. As a result, when the entire ink is cured, phase separation occurs between this polymer portion and a monomer portion, and fine irregularities are formed on surfaces of the ink droplets which have landed on the substrate. Examples of the polymer include a urethane polymer and a urethane acrylic polymer having a molecular weight of 2,000 or more and 15,000 or less.

(c) Before an active ray curable ink is applied, a pretreatment liquid containing a polyvalent metal salt, a cationic polymer, an acid, or the like is previously applied onto paper.

When the ink is applied onto the pretreatment liquid, a pigment in the ink aggregates due to an influence of an acid, undergoes a step of irradiation with an active ray in this state, and fine irregularities are thereby formed on surfaces of the ink droplets which have landed on the substrate. Examples of the acid include a dicarboxylic acid such as adipic acid.

(d) A volatile substance having a boiling point of about 120 to 180° C. is added in an amount of about 1 to 5% by mass relative to the total mass of an ink, and the ink droplets which have landed on the substrate are irradiated with an active ray while being heated to about 70° C.

As a result, a pore shape formed when the volatile substance rapidly volatilizes from surfaces of the ink droplets which have landed on the substrate remains on surfaces of the cured ink droplets. Examples of the volatile substance include propylene glycol monomethyl ether and diethylene glycol monomethyl ether acetate.

<Inkjet Recording Apparatus>

The inkjet recording method can be performed using an active ray curable inkjet type inkjet recording apparatus.

The inkjet recording apparatus includes a recording head for discharging an active ray curable inkjet ink, an ink tank for storing the active ray curable inkjet ink supplied to the recording head, and an irradiation unit for irradiating ink droplets discharged from the recording head with an active ray. The inkjet recording apparatus may include a pretreatment liquid application unit for applying the above pretreatment liquid, a heating unit for heating ink droplets which have landed, a cooling unit for cooling the ink droplets which have landed, and the like.

The active ray curable inkjet type inkjet recording apparatus includes a line recording type (single pass recording type) apparatus and a serial recording type apparatus. It is only required to select the type according to a required resolution of an image and a recording speed, but the line recording type (single pass recording type) apparatus is preferable from a viewpoint of high-speed recording.

### Examples

Hereinafter, the present invention will be described in more detail with reference to Examples. The scope of the present invention is not construed as being limited by these Examples.

<Preparation of Pigment Dispersion>

### (Pigment Dispersion Y)

In a stainless steel beaker, 10 parts by mass of EFKA 7701 (pigment dispersant) manufactured by BASF Co., Ltd. and 70 parts by mass of APG-100 (photopolymerizable compound: dipropylene glycol diacrylate) manufactured by Shin Nakamura Chemical Co., Ltd. were put, and were heated and stirred. The obtained solution was cooled. Thereafter, 20 parts by mass of NOVOPERM YELLOW H2G (pigment) manufactured by Clariant Co., Ltd. was added thereto, and the resulting mixture was put in a glass bottle together with zirconia beads having a diameter of 0.5 mm. The glass bottle was sealed, and the mixture was dispersed. Thereafter, the zirconia beads were removed to prepare yellow pigment dispersion Y.

(Pigment Dispersion C)

Cyan pigment dispersion C was prepared in the same manner as preparation of pigment dispersion Y except that IRGALITE BLUE GLVO manufactured by BASF Co., Ltd. was used as the pigment.

(Pigment Dispersion M)

Magenta pigment dispersion M was prepared in the same manner as preparation of pigment dispersion Y except that CINQUASIA MAGENTA RT-355D manufactured by BASF Co., Ltd. was used as the pigment.

(Pigment Dispersion K)

Black pigment dispersion K was prepared in the same manner as preparation of pigment dispersion Y except that SPECIAL BLACK 250 manufactured by BASF Co., Ltd. was used as the pigment.

<Preparation of Ink>

An active ray curable inkjet ink was prepared as follows.

(Active ray curable inkjet ink Y1)

12.5 parts by mass of pigment dispersion Y prepared above, 30.0 parts by mass of SR210A (polyethylene glycol #200 dimethacrylate) manufactured by Sartomer Co., Inc., 20.0 parts by mass of APG-100 (photopolymerizable compound: dipropylene glycol diacrylate) manufactured by Shin Nakamura Chemical Co., Ltd., 26.3 parts by mass of SR499 (photopolymerizable compound) manufactured by Sartomer Co., Inc., 4.0 parts by mass of SR494 (photopolymerizable compound) manufactured by Sartomer Co., Inc., 7.0 parts by mass of DAROCURE TPO (photopolymerization initiator) manufactured by BASF Co., Ltd. (trade name:), and 0.2 parts by mass of UV10 (polymerization inhibitor) manufactured by BASF Co., Ltd. were mixed, and stirred at 80° C. The obtained solution was filtered through a Teflon (registered trademark) 3 μm membrane filter manufactured by ADVATEC Corporation to prepare ink Y1.

(Active Ray Curable Inkjet Inks M1, C1, and K1)

Inks M1, C1, and K1 were prepared in the same manner as preparation of active ray curable inkjet ink Y1 except that pigment dispersions M, C, and K were used in place of pigment dispersion Y, respectively.

(Active ray curable inkjet inks Y2, M2, C2, and K2)

In preparation of active ray curable inkjet inks Y1, M1, C1, and K1, instead of adding 0.5 part by mass of the tetrazole compound BHT-2NH₃ (5,5-bi-1H-tetrazole⋅diammonium salt: manufactured by TOYOBO Co., Ltd.), the same amount of SR210A was reduced to prepare inks Y2, M2, C2, and K2.

(Active Ray Curable Inkjet Ink C3)

In preparation of active ray curable inkjet ink C1, instead of adding 0.5 part by mass of the tetrazole compound P5T (5-phenyl-1H-tetrazole: manufactured by TOYOBO Co., Ltd.), the same amount of SR210A was reduced to prepare ink C3.

(Active Ray Curable Inkjet Ink C4)

12.5 parts by mass of pigment dispersion C prepared above, 58.8 parts by mass of dimethylacrylamide (photopolymerizable compound) manufactured by JK Chemicals, 12.5 parts by mass of SR210A (polyethylene glycol #200 dimethacrylate) manufactured by Sartomer Co., Inc., 10.0 parts by mass of a urethane polymer prepared by a method described below, 6.0 parts by mass of DAROCURE TPO (photopolymerization initiator) manufactured by BASF Co., Ltd., and 0.2 parts by mass of UV10 (polymerization inhibitor) manufactured by BASF Co., Ltd. were mixed, and stirred at 80° C. The obtained solution was filtered through a Teflon (registered trademark) 3 μm membrane filter manufactured by ADVATEC Corporation to prepare ink C4.

[Preparation of Urethane Polymer]

ETERNACOLL UH-100 which is a polypropylene glycol having a weight average molecular weight of about 1000 (“ETERNACOLL” is a registered trademark of Ube Industries, Ltd.), manufactured by Ube Industries, Ltd., and norbornene methane isocyanate were mixed at a molar ratio of 1:1, and toluene and a tin catalyst were further added thereto to obtain a mixed solution. The mixed solution was heated to 70° C. After 3 hours, hydroxyethyl acrylate (reaction terminator) was added thereto in such an amount that a molar ratio to polycarbonate diol was 4:1, and the resulting mixture was allowed to stand for 2 hours to obtain urethane polymer A having a weight average molecular weight of 3000 and a functional group equivalent of 2.

Urethane polymer B having a weight average molecular weight of 3000 and a functional group equivalent of 0 was obtained in a similar manner to urethane polymer A except that the reaction terminator was changed to ethanol.

Urethane polymer A and urethane polymer B were mixed in such an amount that a molar ratio therebetween was 1:1 to obtain a urethane polymer having a weight average molecular weight of 3000 and a functional group equivalent of 1.

(Active Ray Curable Inkjet Ink K3)

Ink K3 was prepared in the same manner as preparation of active ray curable inkjet ink C4 except that pigment dispersion K was used in place of pigment dispersion C.

(Image Formation)

[Formation of Images Y1, M1, C1, and K1]

A monochromatic printed matter was created using a line recording type inkjet recording apparatus. An ink supply system of the inkjet recording apparatus includes an ink tank, a supply pipe, a sub ink tank immediately before a head, a pipeline with a filter, and a piezo head (recording head) communicating to each other in this order. The prepared inks Y1, M1, C1, and K1 were supplied to the ink supply system of the inkjet recording apparatus.

The recording head used was an inkjet head having 1776 nozzles, manufactured by Konica Minolta, Inc., and had a resolution of 600 dpi. An applied voltage was adjusted such that an appropriate amount of droplets capable of forming a solid image were discharged, two heads were arranged in a zigzag shape, and an image with a resolution of 1200 dpi×1200 dpi was recorded. Dpi represents the number of dots per 2.54 cm. The image was formed in an environment of 23° C. and 55% RH.

Each of inks Y1, M1, C1, and K1 was continuously discharged (driven) under conditions that printing ratios were 30% and 100% using the above recording head.

Then, each of inks Y1, M1, C1, and K1 was caused to land on printing coated paper (Maricoat paper, manufactured by Hokuetsu Kishu Paper Co., Ltd.).

After image formation, exposure was performed under conditions of 4 W 800 mJ by an LED lamp (manufactured by Heraeus K.K., 8 W/cm², 395 nm, water cooled unit) disposed in a downstream portion of the inkjet recording apparatus. Then, the ink which had landed on the printing coated paper was cured.

An image formed in this way from ink Y1 and including two solid areas with printing ratios of 30% and 100% was referred to as image Y1. An image similarly formed from ink M1 was referred to as image M1. An image similarly formed from ink C1 was referred to as image C1. An image similarly formed from ink K1 was referred to as image K1.

[Formation of Image Y2]

Image Y2 was formed similarly except that ink Y2 was used in place of ink Y1 in formation of image Y1.

[Formation of Image M2]

Image M2 was formed similarly except that ink M2 was used in place of ink M1 in formation of image M1.

[Formation of Image C2]

Image C2 was formed similarly except that ink C2 was used in place of ink C1 in formation of image C1.

[Formation of Image K2]

Image K2 was formed similarly except that ink K2 was used in place of ink K1 in formation of image K1.

[Formation of Image C3]

Image C3 was formed similarly except that ink C3 was used in place of ink Y1 in formation of image C1.

Incidentally, when printed matters Y2, M2, C2, K2, and C3 were prepared, exposure was performed under conditions of 4 W 800 mJ to cure each ink droplet which had landed on printing coated paper. At the same time, each tetrazole compound absorbed an ultraviolet ray, and was decomposed. Fine bubbles of nitrogen were generated, and pores formed due to the bubbles were generated on a surface of a coating film.

[Formation of Image C4]

Image C4 was formed similarly except that ink C4 was used in place of ink C1 and the recording head was heated to 80° C. in order to reduce an ink viscosity to eject the ink easily in formation of image C1.

[Formation of Image K3]

Image K3 was formed similarly except that ink K3 was used in place of ink C4 in formation of image C4.

Surface roughness Sa (μm) and a 60° gloss value were measured for an area with a printing ratio of 30% and an area with a printing ratio of 100% included in images Y1, M1, C1, K1, Y2, M2, C2, K2, C3, C4, and K3. An absolute value of a difference between the gloss value of the area with a printing ratio of 30% and the gloss value of the area with a printing ratio of 100% was calculated. Results are indicated in Table 1.

(Sa and Gloss Value)

Here, surface roughness was measured with a laser microscope VK-X250 manufactured by KEYENCE CORPORATION with an objective lens magnification of 150 times, and surface roughness Sa (arithmetic average height) within an area of 20 μm×20 μm at a center of each dot was measured.

For glossiness, a 60° gloss value was measured with a handy gloss meter PG-II manufactured by Nippon Denshoku Industries Co., Ltd.

(Discomfort)

By visually comparing an area with a printing ratio of 30% and an area with a printing ratio of 100% included in images Y1, M1, C1, K1, Y2, M2, C2, K2, C3, C4, and K3, discomfort was evaluated according to the following criteria. Results are indicated in Table 1.

1. Glare in the area with a printing ratio of 100% is significant, glare of each dot is felt even in the area with a printing ratio of 30%, and discomfort is felt due to a difference in gloss between the area with a printing ratio of 30% and the area with a printing ratio of 100%.

2. Glare in the area with a printing ratio of 100% is significant, and discomfort is felt due to a difference in gloss between the area with a printing ratio of 30% and the area with a printing ratio of 100%.

3. Almost no discomfort is felt due to a difference in gloss between the area with a printing ratio of 30% and the area with a printing ratio of 100%.

TABLE 1

| | Printing | | Printing | | | |
|---|---|---|---|---|---|---|
| | ratio 30% | | ratio 100% | | | |
| | Sa | 60° gloss | Sa | 60° gloss | Difference in | Sensory |
| Image | [μm] | value | [μm] | value | gloss value | evaluation |
| Y1 | 0.02 | 39 | 0.02 | 86 | 47 | 1 |
| M1 | 0.03 | 35 | 0.03 | 72 | 43 | 2 |
| C1 | 0.02 | 40 | 0.02 | 91 | 51 | 1 |
| K1 | 0.02 | 38 | 0.02 | 87 | 49 | 1 |
| Y2 | 0.15 | 21 | 0.16 | 29 | 8 | 3 |
| M2 | 0.20 | 15 | 0.19 | 20 | 5 | 3 |
| C2 | 0.18 | 17 | 0.17 | 23 | 6 | 3 |
| K2 | 0.12 | 29 | 0.11 | 32 | 3 | 3 |
| C3 | 0.14 | 18 | 0.14 | 22 | 4 | 3 |
| C4 | 0.11 | 26 | 0.09 | 37 | 11 | 3 |
| K3 | 0.18 | 19 | 0.16 | 25 | 6 | 3 |

Images Y1, M1, C1, and K1 have small values of surface roughness (Sa) both in a case of a printing ratio of 30% and in a case of a printing ratio of 100%. This indicates that a dot surface is smooth. Therefore, a 60° gloss value in the area with a printing ratio of 30% is about 40, a 60° gloss value in the area with a printing ratio of 100% is about 70 to 90, and a difference in gloss value between areas with different printing ratios is large. That is, a gloss value is high both in the area with a low printing ratio and in the area with a high printing ratio, and the gloss value largely fluctuates depending on a printing ratio. This seems to cause glare to be felt both in the area with a low printing ratio and in the area with a high printing ratio and to cause discomfort to be felt due to a difference in gloss in sensory evaluation.

Meanwhile, each of images Y2, M2, C2, K2, C3, C4, and K3 had surface roughness (Sa) of a dot surface of 0.05 μm or more and 2.0 μm or less, had a low gloss value both in an area with a low printing ratio and in an area with a high printing ratio, and had a difference of 10 or less in gloss value between both the areas. Therefore, it is considered that no discomfort of gloss was felt due to a difference in printing ratio in sensory evaluation.

Surface roughness Sa of each of images Y2, M2, C2, K2, C3, C4, and K3 was 0.11 μm or more and 0.20 μm or less. A difference between the largest value of Sa and the smallest value of Sa among Sa values measured from these images was 0.15 μm or less. Therefore, in these images, a difference in gloss value for each color is small, and in any color, a difference in gloss value is small regardless of a printing ratio. Therefore, the present invention has provided an image causing no discomfort due to a difference in gloss in an image and having an excellent appearance even in a full-color image.

According to an embodiment of the present invention, an image based on a completely new concept is provided.

Although embodiments of the present invention have been described and illustrated in detail, it is clearly understood that the same is by way of illustration and example only and not limitation, the scope of the present invention should be interpreted by terms of the appended claims.

What is claimed is:

1. An image comprising a plurality of dots formed from droplets of an active ray curable inkjet ink, wherein
an average value of surface roughness (Sa) measured from the plurality of dots in an area of a reference length of 20 μm set on a surface of one dot arbitrarily selected from the plurality of dots is 0.05 μm or more and 0.2 μm or less.

2. The image according to claim 1, comprising a high printing ratio area with a printing ratio of 70% or more and 100% or less, wherein the average value of Sa measured only from the high printing ratio area is 0.05 μm or more and 0.2 μm or less.

3. The image according to claim 1, comprising a high printing ratio area with a printing ratio of 70% or more and 100% or less, wherein the high printing ratio area has a 60° gloss value of 15 or more and 45 or less.

4. The image according to claim 1, comprising a low printing ratio area with a printing ratio of 5% or more and 50% or less, wherein the average value of Sa measured only from the low printing ratio area is 0.05 μm or more and 0.2 μm or less.

5. The image according to claim 1, comprising a low printing ratio area with a printing ratio of 5% or more and 50% or less, wherein the low printing ratio area has a 60° gloss value of 15 or more and 45 or less.

6. The image according to claim 1, comprising a high printing ratio area with a printing ratio of 70% or more and 100% or less and a low printing ratio area with a printing ratio of 5% or more and 50% or less, wherein each of the average value of Sa measured only from the high printing ratio area and the average value of Sa measured only from the low printing ratio area is 0.05 μm or more and 0.2 μm or less.

7. The image according to claim 1, comprising a high printing ratio area with a printing ratio of 70% or more and 100% or less and a low printing ratio area with a printing ratio of 5% or more and 50% or less, wherein a difference in 60° gloss value between the high printing ratio area and the low printing ratio area is 3 or more and 20 or less.

8. The image according to claim 1, wherein the dot includes a plurality of colored dots selected from the group consisting of a yellow dot formed using a yellow ink, a magenta dot formed using a magenta ink, a cyan dot formed using a cyan ink, a black dot formed using a black ink, and a white dot formed using a white ink.

9. The image according to claim 8, comprising a high printing ratio area with a printing ratio of 70% or more and 100% or less, wherein the average value of Sa measured only from the high printing ratio area is 0.05 μm or more and 0.2 μm or less.

10. The image according to claim 8, comprising a high printing ratio area with a printing ratio of 70% or more and 100% or less, wherein the high printing ratio area has a 60° gloss value of 15 or more and 45 or less.

11. The image according to claim 8, comprising a low printing ratio area with a printing ratio of 5% or more and 50% or less, wherein the average value of Sa measured only from the low printing ratio area is 0.05 μm or more and 0.2 μm or less.

12. The image according to claim 8, comprising a low printing ratio area with a printing ratio of 5% or more and 50% or less, wherein the low printing ratio area has a 60° gloss value of 15 or more and 45 or less.

13. The image according to claim 8, comprising a high printing ratio area with a printing ratio of 70% or more and 100% or less and a low printing ratio area with a printing ratio of 5% or more and 50% or less, wherein each of the average value of Sa measured only from the high printing ratio area and the average value of Sa measured only from the low printing ratio area is 0.05 μm or more and 0.2 μm or less.

14. The image according to claim 8, comprising a high printing ratio area with a printing ratio of 70% or more and 100% or less and a low printing ratio area with a printing ratio of 5% or more and 50% or less, wherein a difference in 60° gloss value between the high printing ratio area and the low printing ratio area is 3 or more and 20 or less.

15. The image according to claim 8, wherein the plurality of colored dots includes a colored dot having the average value of Sa of 0.05 μm or more and 0.2 μm or less measured only from the colored dot.

16. The image according to claim 8, wherein the plurality of colored dots consists of a colored dot having the average value of Sa of 0.05 μm or more and 0.2 μm or less measured only from the colored dot.

17. The image according to claim 8, wherein
the plurality of colored dots includes a pair of colored dots of two colors,
the pair of colored dots of two colors consists of colored dots of two different colors selected from the plurality of colored dots, and
a difference between the average value of Sa measured only from the colored dots of one color constituting the pair of colored dots of two colors and the average value of Sa measured only from the colored dots of the other color constituting the pair of colored dots of two colors is 0.15 μm or less.

18. The image according to claim 8, wherein
in all the pairs of colored dots of two colors, consisting of colored dots of two different colors selected from the plurality of colored dots,
a difference between the average value of Sa measured only from the colored dots of one color constituting the pair of colored dots of two colors and the average value of Sa measured only from the colored dots of the other color constituting the pair of colored dots of two colors is 0.15 μm or less.
